(19) United States
(12) Patent Application Publication
(10) Pub. No.: US 2014/0365351 A1
(43) Pub. Date: Dec. 11, 2014

(54) COMMON ORDER QUEUE FOR MULTIPLE TRADING PLATFORMS

(71) Applicant: TD AMERITRADE IP COMPANY, INC., Omaha, NE (US)

(72) Inventors: Jesse CARLBERG, Bellevue, NE (US); Michael COLEMAN, Omaha, NE (US); Heather NEUBAUER, Omaha, NE (US); Kevin DALKE, Omaha, NE (US)

(21) Appl. No.: 13/912,993

(22) Filed: Jun. 7, 2013

(51) Int. Cl. G06Q 40/04

(52) U.S. Cl. CPC G06Q 40/04
USPC 705/37

(57) ABSTRACT

Methods, systems, and apparatuses, including computer programs encoded on computer-readable media, for receiving a trade from a client using a first platform of a plurality of platforms. Each of the platforms are configured to display a distinct compilation of information. The trade is placed in a queue accessible by the plurality of platforms. First indicia are provided associated with the trade from the first platform to the client. A request for trades in the queue is received from a second platform of the plurality of platforms. The trade in the queue is provided to the second platform responsive to the request for trades in the queue. Second indicia associated with the trade are provided from the second platform to the client. The second indicia is not available from the first platform.

### BACKGROUND

In a trading system, a trading application permits buying and selling of securities using computing devices. Web servers, for example, can permit trades to be executed online. Such web servers can access multiple trading platforms that convey various types of information to users. A particular platform may be appropriate for a sophisticated user and may be inappropriate for a novice user. However, the novice user may wish to access the levels of information generally available to more experienced users. Further, it can be convenient to access one platform to initiate an action with respect to a trade and to access another platform subsequently. Trading applications that confine users to particular platforms do not permit such cross-over to occur. Additionally, trading applications do not facilitate online discussion about such trading platforms or provide for exchange of ideas and discourse among traders.

### SUMMARY

In general, one aspect of the subject matter described in this specification can be implemented in systems, methods, and computer-readable media for receiving a trade from a client using a first platform of a plurality of platforms. Each of the platforms are configured to display a distinct compilation of information. The trade is placed in a queue accessible by the plurality of platforms. First indicia are provided associated with the trade from the first platform to the client. A request for trades in the queue is received from a second platform of the plurality of platforms. The trade in the queue is provided to the second platform responsive to the request for trades in the queue. Second indicia associated with the trade are provided from the second platform to the client. The second indicia is not available from the first platform. Other implementations of this aspect include corresponding systems and computer-readable media configured to perform the actions of the method.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims. Like reference numbers and designations in the various drawings indicate like elements. For purposes of clarity, not every component may be labeled in every drawing.

FIG. 1 is a block diagram of a system in accordance with an illustrative implementation.

FIG. 2 is a flow diagram of a process for placing an order in accordance with an illustrative implementation.

FIG. 3 is a block diagram of a computer system in accordance with an illustrative implementation.

### DETAILED DESCRIPTION

Following below are more detailed descriptions of various concepts related to, and implementations of, systems, methods, and computer-readable media for an order queue that is accessible to multiple trading platforms. The various concepts introduced above and discussed in greater detail below may be implemented in any of numerous ways, as the described concepts are not limited to any particular manner of implementation. Examples of specific implementations and applications are provided primarily for illustrative purposes.

Electronic trading platforms provide for buying and selling of securities using a computing device. Trading orders are used to accomplish buying and selling activities. Order requests, such as fill order requests, can be sent to a trading platform hosted by a system. A fill order request can identify a security, the quantity of the security that a user wishes to purchase, and the price at which the user wishes to purchase. Conversely, a sell order can identify the security, the quantity of the security, and the price at which the user wishes to sell stock.

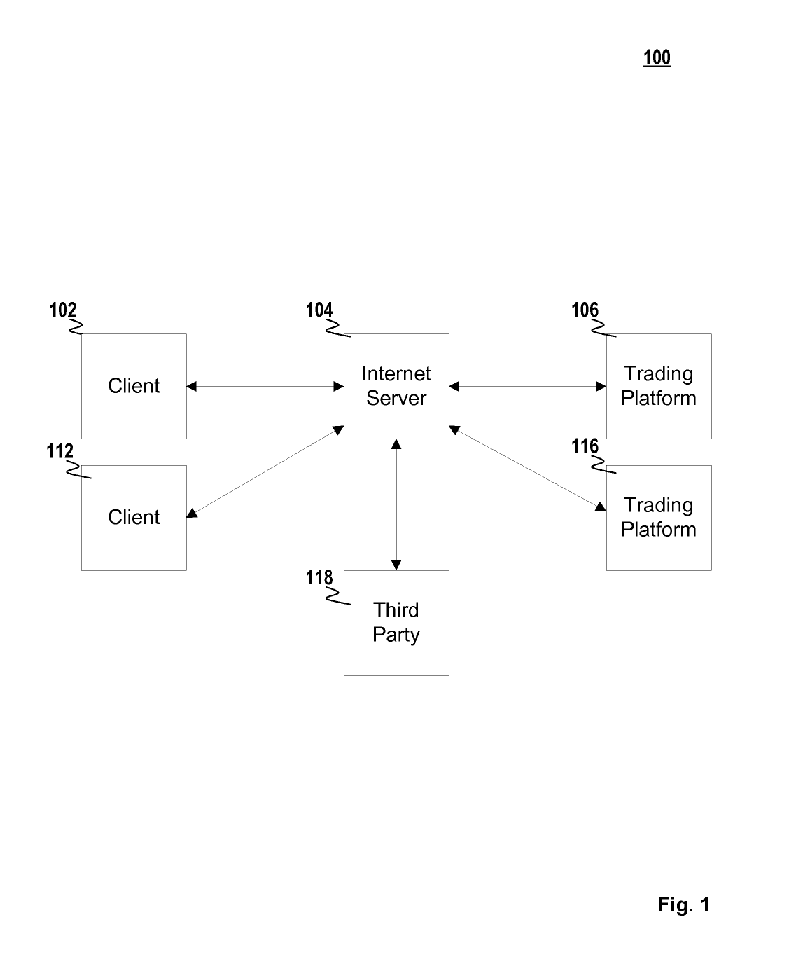

FIG. 1 illustrates a block diagram of a system 100 for submitting electronic trading orders. An Internet server 104 grants access to a user via a client 102. The internet server 104 can access a trading platform 106. The internet server 104 can receive requests from the client 102 and send content to the client 102. For example, the internet server 104 can receive a create order request from a client 102, build a fill order request, send the fill order request to the trading platform 106, receive a confirmation from the trading platform 106 in response, and send an indication of the confirmation to the client 102.

The internet server 104 can provide multiple clients, e.g., 102 and 112, access to the trading platform 106. In addition, the internet server 104 can provide clients access to other trading platforms, e.g., trading platform 116. In another implementation, clients can access the trading platforms 106 and 116 using one or more internet servers. As described in greater detail below, each trading platform can provide clients with different information and/or user interfaces. Some data can be common throughout the trading platforms. For example, as described in greater detail below, saved trades and/or queued trades can be available on all of the trading platforms.

The purchase of stocks and/or other securities can be achieved through a trading platform. Some securities or types of trades may only be available through particular trading platforms, while other securities are available through any of the trading platforms. In one implementation, a trading platform is configured based upon an expected experience level of its users. For example, the trading platform 106 can be geared towards novice or low volume users. The trading platform 106, therefore, can give users the ability to purchase common securities, such as stocks, mutual funds, options, etc. The trading platform 116 can provide access to more advanced trading features that are useful to expert or high volume traders. Further, the different trading platforms, in one implementation, provide different information regarding securities, indices or trades.

Users can to take advantage of two or more trading platforms. For example, a particular user may be able to access both the trading platform 106 and the trading platform 116. Data associated with the user can be shared between the trading platforms. For example, the trading platforms can access a data store that contains data associated with the user. In another implementation, the trading platforms can communicate with one another to share the user's data. In one implementation, the user can save or place an order in one trading platform, e.g., trading platform 106. When the user accesses the trading platform 116, the user will have access to their saved or pending order placed in the trading platform 106. This allows the user to conveniently use the features of both trading platforms in regard to all of their saved orders and/or queued orders.

The trading platforms can provide various indicia to users. In some implementations, indicia include product-specific and user-specific indicia. Product-specific indicia for a given investment product include an implied volatility, a last price of an option chain, an expiration for an option, a bid price, an ask price, and a product symbol. In some implementations, user-specific indicia include a current market value of all holdings, daily fluctuations in total market value expressible in percentages and units of currency, and performance metrics for top holdings, for example. Further examples of indicia include an options chain, a stock symbol, a maximum profit calculation, a maximum loss calculation, and calculation of an effect of the order on buying power, for example.

Further, access to indicia can guide users in making a decision about option contracts between buyers and sellers in which the buyer pays a premium to acquire the right to purchase a futures contract at a strike price, i.e., call options, as well as options providing the buyer the right to sell a futures contract at a strike price during an option period, i.e., a put option. Such indicia can further guide users as to whether to engage in straddles or strangles and whether to adopt short or long positions. For example, if call options have been trading at a premium, an indication of a reduction in volatility of pricing could suggest a risk that a trade would incur a loss.

In some implementations of an exemplary system for processing electronic trading orders, the system includes a display configured to convey indicia of interest to a user. The display can render the indicia accessible to the user by representing and compiling the indicia in formats including charts, plots, graphs, tabular data, indexed data, lists, raw text, or any combination of such formats. In at least one implementation, the indicia can be stored and updated through a server, such as the server 104 shown in FIG. 1. The server is accessed in order to generate the display on a client.

The display can include results from a study of investment products. For example, the display can depict projected increases in value for an investment product based on a customizable study. The customizable study, for example, could be configured to assess a short straddle of the front month and to depict the results overlaid on a chart indicating an expected ‘move’ or shift in market pricing. Results can be gathered in a compilation of indicia. In some implementations, at least one compilation includes a three year daily moving average and correlation study of market prices.

The display can further depict a risk profile of an options spread on a webpage for a given option. Such a webpage can provide an indication of an expected return on investment (“ROI”) of adopting a position. Access to a computation of the ROI can permit a user to quickly ascertain a margin that must be realized in order to accrue a given amount of profit. In some implementations, the ROI can be displayed as a percentage.

Further, in at least one implementation, the user can create a watchlist based on at least one investment product. For example, the user can create the watchlist based on stocks that the user frequently trades. In some implementations, the user can maintain multiple watchlists that can include, by way of example, both investment products that the user currently trades and investment products that the user desires to trade. The system is configured to convey information about each item on a watchlist that includes the indicia described above. In addition, the watchlist can be accessible through any of the trading platforms. Accordingly, a user can create a watchlist in one trading platform, and access the watch list in another trading platform. This allows the user to leverage the features of the trading platforms without having to recreate a watchlist in each of the trading platforms.

In some implementations, the system is further configured to permit a user to queue an order for execution. An order can include a fill or sell order or a spread order that can be any combination of fill and sell orders. In some implementations, the system is configured to permit a user to select only a fill or sell order rather than the spread order. In some implementations, the user can select an order to queue from a list of saved orders. The user can also enter an order and rather than execute the order, queue the order. In another implementation, a third-party can add a queued order to a user's order queue. For example, a third-party can provide a trading idea for one or more securities. The trading idea can include all the necessary information to execute the order described in the trading idea. FIG. 1 illustrates a third party 118 than provide the order to be queued into one or more user queues to the internet server 104. This order can be placed in a user's order queue. The user can then review the queued order and determine whether or not to place the trade. In one implementation, a user can subscribe to trading ideas from the third party. The user will then have a queued order for each trading idea sent by the third party. For example, the third party could be a portfolio manager that manages risk in a particular way. A user could then monitor their queued orders from this portfolio manager to execute a strategy similar to the portfolio manager.

In some implementations, the queue in which the order is placed is a central order queue that can be executed or removed from any of a plurality of platforms. In other implementations, each platform has an associated queue that, in turn, communicates with the central order queue. In some implementations, a hub provides a host for the central queue. The hub can be on the internet server 104 or another server that is accessible to the internet server 104 and/or the trading platforms. The hub can also be hosted, for example, using a cloud computing system.

In some implementations, there can be queue rules. Queue rules can be ran prior to an order being placed in the queue. For example, there can be a check to ensure that a particular trade is a valid trade before placing the order in the queue. If the trade is not valid, queuing the trade can be denied. As one specific example, the security being traded an be check to ensure that the user can trade that security. Queue rules can also be ran at various times. For example, a queue order can be for an option that has an expiration date. Once the expiration date passes, the order cannot be placed. A queue rule can be ran periodically and can remove any order that has expired. In some implementations, there are no queue rules and any trade can be added to a user's queue. Regardless if queue rules are used, when a queued order is executed, trading rules can run to ensure that the trade can be made.

In some implementations, once the order enters the queue, the order is routed to a plurality of trading platforms. In at least one implementation, the order is routed to a first trading platform, a second trading platform, and a third trading platform. In other implementations, each of the plurality of trading platforms is in communication with the central order queue. Each trading platform differs from the other trading platforms with respect to content and data displayed on each platform. In certain implementations, each of the plurality of platforms may provide a different interface, for example a mobile application, a web browser interface, and PC software. The display includes a configuration of indicia corresponding to their layout on a screen. Each trading platform, for example, can be configured to display different indicia in different configurations that are not common to the indicia and/or configurations of other trading platforms. In some implementations, each platform displays results from customized studies that are not readily available on the other platforms. Although data used to generate such results can be accessed from each platform in some implementations, the user must use advanced features of some platforms to view the results. In some implementations, certain compilations of indicia are not displayed as default compilations unless the user creates a customized compilation.

The user can enter the order using a plurality of devices. The user can initiate the order in a first platform using a first device. The user can then view and access the order via a second platform or a third platform. For example, in one implementation, the user enters the order on a mobile application having an internet interface and then accesses it using a proprietary software-based application. In some implementations, the user must subscribe to one of the platforms in order to enter the order. Further, in certain implementations one or more of the platforms is accessible on more than one device. For example, a web-based browser interface may be accessible on a mobile device and also accessible via a PC.

In some implementations, each trading platform displays indicia based on an anticipated level of user experience. In such implementations, the first trading platform can be configured to convey information to a novice user, the second trading platform can be configured to convey information to an intermediate user, and the third trading platform can be configured to convey information to advanced users, for example.

Thus, a variety of compilations of indicia are distributed across the plurality of platforms. The server permits users of varying degrees of experience and sophistication can take advantage of the order queue from any of the platforms and can access the compilations that are distinct to each platform. In some implementations, each platform can be deployed on a separate application, and each application is configured to be hosted on the plurality of devices. At any time relative to placement of the order, each platform permits the user to analyze the order. For example, after placing the order, the user is presented with information about subsequent fluctuations in the market price of the ordered investment product. Further, each platform can distribute data about the order to the other platforms.

In some implementations, each platform includes supplemental information that is directed towards users of an anticipated experience level. Such supplemental information can include, for example, videos and webinars for beginning traders. Additional content may be provided to guide novice users through various features of each platform and to educate such users.

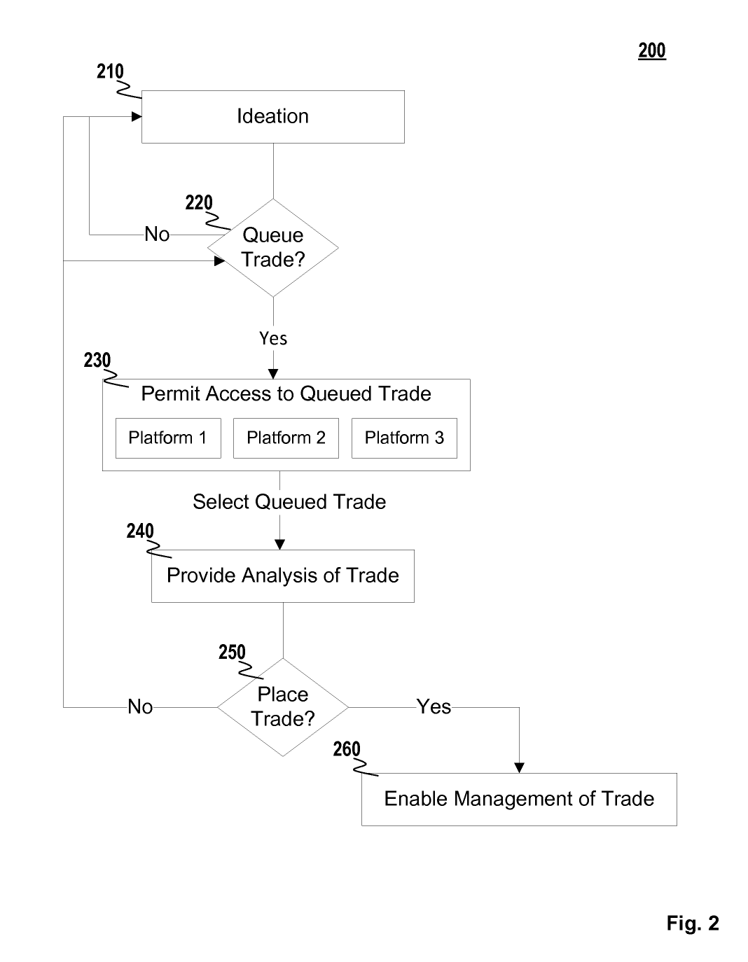

FIG. 2 is a flow diagram of a process 200 for placing an order in accordance with an illustrative implementation. The process 200 can be implemented on a computing device. In one implementation, the process 200 is encoded on a computer-readable medium that contains instructions that, when executed by a computing device, cause the computing device to perform operations of process 200. The process can include providing, on a trading platform, an interface for a user to formulating a trade; providing an environment such as a forum in which a user can engage in learning; receiving on the trading platform, a user's decision whether to queue a trade, enabling access to and analysis of the trade, providing for placement of the trade, and facilitating management of the trade. Initially, the platform allows a trade to be formulated based on an ideation of the user (210). For example, in some implementations, a user may form an ideation that motivates the decision to queue a trade based on marketplace information provided by the trading platform, previously established trading strategies, opinions, other sources, etc.

Referring again to FIG. 2, the trading platform is configured to receive a decision made by a user as to whether to queue a trade for a given investment product (220). For example, a user's ideation in rendering such a decision may be based on intelligence gleaned from the forum or the display. In some implementations, if the trading platform receives a decision from a user not to proceed with queuing a trade, then the trading platform can present a platform navigator that includes allows a user to discuss the trade.

If the trading platform receives a decision from a user to proceed with queuing a trade, the platform proceeds to queue the trade. After queuing the trade, a server, such as the internet server 104 shown in FIG. 1, provides access to the queued trade from any of a plurality of platforms, for example, platform 1, platform 2, or platform 3 (230). Accordingly, a user can queue a trade in one trading platform and access the queued trade in another trading platform. This avoids the user from having to duplicate queuing the same order in multiple trading platforms, while allowing the user to leverage the features of the trading platforms in regard to this and any other queued trade.

The server allows a user to select a queued trade. Following the selection of the queued trade, the platform can analyze the trade (240). Such analysis may be conducted in the context of a forum, based on the compilations of indicia provided by one or more trading platforms, etc. For example, the trading platform can display indicia, facilitating an analysis of a prospective trade. The trading platform can, as mentioned above, receive a decision (e.g., a user-made determination) as to whether to place the trade (250). If the trading platform receives a decision not to place the trade, the trading platform can return to the platform navigator, where users can continue to refine their investment knowledge and prepare for a next trading decision (210). Alternatively, the platform may receive a decision to proceed with the trade. If so, the platform is configured to place the trade and then provide for management of the trade after placement (260). Such management can include, for example, evaluating the return on investment of the trade and monitoring of the market price.

In some implementations, the discussion forum may be integrated within applications that deploy the platforms. Alternatively, the discussion forum can be hosted in venues such as internet discussion chat rooms, listservs, message boards, messaging systems, or any combination of such venues. In some implementations, a discussion forum may span multiple venues. In some implementations, the discussion forum can be fully or partially available for public viewing by any internet user. In other instances, none of the discussion forum is accessible to the public, and access is permitted only to a registered user.

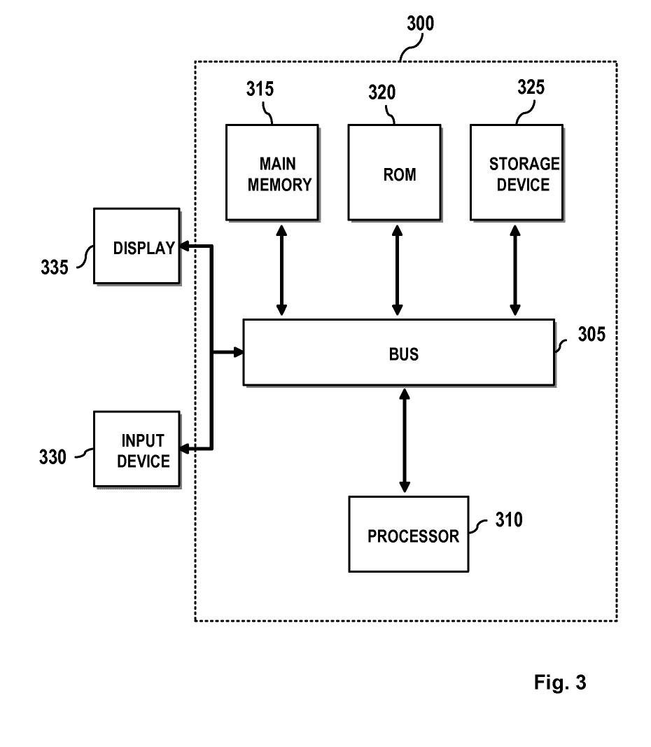

FIG. 3 is a block diagram of a computer system in accordance with an illustrative implementation. The computer system or computing device 300 can be used to implement cell phones, clients, servers, cloud computing resources, etc. The computing system 300 includes a bus 305 or other communication component for communicating information and a processor 310 or processing circuit coupled to the bus 305 for processing information. The computing system 300 can also include one or more processors 310 or processing circuits coupled to the bus for processing information. The computing system 300 also includes main memory 315, such as a random access memory (RAM) or other dynamic storage device, coupled to the bus 305 for storing information, and instructions to be executed by the processor 310. Main memory 315 can also be used for storing position information, temporary variables, or other intermediate information during execution of instructions by the processor 310. The computing system 300 may further include a read only memory (ROM) 320 or other static storage device coupled to the bus 305 for storing static information and instructions for the processor 310. A storage device 325, such as a solid state device, magnetic disk or optical disk, is coupled to the bus 305 for persistently storing information and instructions.

The computing system 300 may be coupled via the bus 305 to a display 335. An input device 330, such as a keyboard, may be coupled to the bus 305 for communicating information and command selections to the processor 310. In another implementation, the input device 330 has a touch screen display 335. The input device 330 can include a cursor control, such as a mouse, a trackball, or cursor direction keys, for communicating direction information and command selections to the processor 310 and for controlling cursor movement on the display 335.

According to various implementations, the processes described herein can be implemented by the computing system 300 in response to the processor 310 executing an arrangement of instructions contained in main memory 315. Such instructions can be read into main memory 315 from another computer-readable medium, such as the storage device 325. Execution of the arrangement of instructions contained in main memory 315 causes the computing system 300 to perform the illustrative processes described herein. One or more processors in a multi-processing arrangement may also be employed to execute the instructions contained in main memory 315.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Moreover, the separation of various system components in the implementations described above should not be understood as requiring such separation in all implementations, and it should be understood that the described program components and systems can generally be integrated in a single software product or packaged into multiple software products.

Similarly, while operations are depicted in the drawings in a particular order, this should not be understood as requiring that such operations be performed in the particular order shown or in sequential order, or that all illustrated operations be performed, to achieve desirable results. Thus, particular implementations of the subject matter have been described. Other implementations are within the scope of the following claims.

1. A method comprising:
receiving, using a processor, a trade from a client using a first platform of a plurality of platforms, each of the platforms being configured to display a distinct compilation of information;
placing the trade in a queue accessible by the plurality of platforms;
providing first indicia associated with the trade from the first platform to the client;
receiving a request for trades in the queue from a second platform of the plurality of platforms;
providing the trade in the queue to the second platform responsive to the request for trades in the queue; and
providing second indicia associated with the trade from the second platform to the client, the second indicia not being available from the first platform.

2. The method of claim 1, further comprising:
receiving a second trade from third party;
associating the second trade with the client; and
queuing the second trade in the queue.

3. The method of claim 1, further comprising verifying the trade is a valid prior to queuing the trade.

4. The method of claim 1, further comprising:
Determining the trade has expired;
Removing the trade from the queue based on determining the trade has expired.

5. The method of claim 1, further comprising:
receiving instructions from the client for executing the trade; and
placing an order to execute the trade with one of the plurality of platforms.

6. The method of claim 5, wherein the compilation of information on the first platform updates following the placing of the order to executed the trade, wherein the second platform places the order.

7. The method of claim 5, wherein the order to execute the trade is placed with the first platform.

8. The method of claim 5, wherein the order to execute the trade is placed with the second platform.

9. The method of claim 1, wherein the compilation of information displayed by each platform is based on a level of user experience corresponding to that platform.

10. A system comprising:
one or more electronic processors configured to:
receive a trade from a client using a first platform of a plurality of platforms, each of the platforms being configured to display a distinct compilation of information;
place the trade in a queue accessible by the plurality of platforms;
provide first indicia associated with the trade from the first platform to the client;
receive a request for trades in the queue from a second platform of the plurality of platforms;
provide the trade in the queue to the second platform responsive to the request for trades in the queue; and
provide second indicia associated with the trade from the second platform to the client, the second indicia not being available from the first platform.

11. The system of claim 10, wherein the one or more electronic processors are further configured to:
receive instructions from the client for executing the trade; and
place an order to execute the trade with one of the plurality of platforms.

12. The system of claim 11, wherein the compilation of information on the first platform updates following the placing of the order to executed the trade, wherein the second platform places the order.

13. The system of claim 11, wherein the order to execute the trade is placed with the first platform.

14. The system of claim 11, wherein the order to execute the trade is placed with the second platform.

15. The system of claim 10, wherein the compilation of information displayed by each platform is based on a level of user experience corresponding to that platform.

16. A non-transitory computer-readable medium having instructions stored thereon, the instructions comprising:
instructions to receive a trade from a client using a first platform of a plurality of platforms, each of the platforms being configured to display a distinct compilation of information;
instructions to place the trade in a queue accessible by the plurality of platforms;
instructions to provide first indicia associated with the trade from the first platform to the client;
instructions to receive a request for trades in the queue from a second platform of the plurality of platforms;
instructions to provide the trade in the queue to the second platform responsive to the request for trades in the queue; and
instructions to provide second indicia associated with the trade from the second platform to the client, the second indicia not being available from the first platform.

17. The non-transitory computer-readable medium of claim 16, wherein instructions further comprise:
instructions to receive instructions from the client for executing the trade; and
instructions to place an order to execute the trade with one of the plurality of platforms.

18. The non-transitory computer-readable medium of claim 17, wherein the compilation of information on the first platform updates following the placing of the order to executed the trade, wherein the second platform places the order.

19. The non-transitory computer-readable medium of claim 17, wherein the order to execute the trade is placed with the first platform.

20. The non-transitory computer-readable medium of claim 17, wherein the order to execute the trade is placed with the second platform.
